(19) United States
(12) Patent Application Publication
(10) Pub. No.: US 2015/0212973 A1
(43) Pub. Date: Jul. 30, 2015

(54) INTEGRATED UTILITY BASED DATA PROCESSING METHODS

(71) Applicants: RUICHUN TANG, Qingdao (CN); CHAO LIU, Qingdao (CN); YILI ZHAI, Qingdao (CN)

(72) Inventors: RUICHUN TANG, Qingdao (CN); CHAO LIU, Qingdao (CN); YILI ZHAI, Qingdao (CN)

(73) Assignee: HAIER GROUP CO., Qingdao (CN)

(21) Appl. No.: 14/444,097

(22) Filed: Jul. 28, 2014

(30) Foreign Application Priority Data
Jan. 28, 2014 (CN) 201410040710.7

(51) Int. Cl. G06F 17/17

(52) U.S. Cl. CPC G06F 17/17

(57) ABSTRACT

A method for processing integrated utility based data includes: obtaining a first integrated utility value according to an association relationship between parameters of a cloud-based media task request and attribute parameters of current cloud-based media resources; allocating the cloud-based media resources according to the first integrated utility value; wherein the association relationship is obtained by calculating: U=ω_{CR}U_{CR}^{total}(P_{CR},RT_{CR},B_{CR})+ω_{CP}U_{CP}^{total}(P_{CP},RT_{CP},B_{CP}), wherein U is the first integrated utility value; and U_{CR}^{total}(P_{CR},RT_{CR},B_{CR})≧uₘᵢₙ^{CR}, uₘᵢₙ^{CR} is the minimum utility value of the task request; and U_{CP}^{total}(P_{CP},RT_{CP},B_{CP})≧uₘᵢₙ^{CP}, uₘᵢₙ^{CP} is the minimum utility value of the resources; and ω_{CR}+ω_{CP}=1, ω_{CR} and ω_{CP} are respective weights of a second integrated utility value U_{CR}^{total}(P_{CR},RT_{CR},B_{CR}) and a third integrated utility value U_{CP}^{total}(P_{CP},RT_{CP},B_{CP}); wherein the parameters of the task request include adjustment factor P_{CR}, response time RT_{CR}, and bandwidth B_{CR}, and wherein the attribute parameters of the resources include adjustment factor P_{CP}, response time RT_{CP}, and bandwidth B_{CP}. An apparatus for processing integrated utility based data is also provided. In some embodiments, integrated utility based data may be processed to achieve the maximized utility to sufficiently increase satisfaction of cloud users during cloud-based media resource allocation.

### CROSS-REFERENCE

This application claims priority to Chinese Patent Application No. 201410040710.7, filed on Jan. 28, 2014, entitled “Integrated Utility Based Data Processing Methods,” which is herein incorporated by reference in its entirety.

### TECHNICAL FIELD

The present technology generally relates to cloud computing techniques, and in particular, relates to integrated utility based data processing methods.

### BACKGROUND

Cloud-based media scheduling services abound in the cloud computing area, but are always subject to restrictions of bandwidth and other computing resources in the process of transmission, reducing satisfaction with balanced scheduling services. Reasonable allocation of cloud resources is a way to increase satisfaction of scheduling services in a cloud computing environment. Thus, the technology of cloud based media resource allocation has become a hot research topic recently. One resource allocation model that involves a combinatorial auction mechanism with energy parameters has been presented, which can improve resource utilization of data centers. A linear bandwidth resource allocation scheme has also been put forward by combining the game theory with congestion control algorithms, thus enhancing the utility value of bandwidth. Moreover, to optimize resources of data centers, the game algorithms of load balancing and virtual machine configuration have comprehensively been considered. However, the above-mentioned strategies are only designed to allocate resources for consideration based on energy consumption of CPs (Cloud Service Providers). These strategies lack the support to QoS (Quality of Service) properties of CRs (Cloud Service Requesters), and have thus become a bottleneck problem of CR satisfaction improvement. Therefore, it is very significant to make a research on overall satisfaction with common cloud resource allocations. The key for the research is to find out an appropriate integrated utility based data processing method.

In existing data processing methods, the minimized response time as the object of integrated utility based data processing is often used. However, the integrated utility based data are not processed from the view of Cloud Service Requesters and Cloud Resources; as a result, when the data is used for cloud based resource allocation, the total cloud service has lower utility.

### SUMMARY

In view of the foregoing, one object of the present technology may relate to provide an integrated utility based data processing method. The following summary involves simple concepts for basic understanding of some aspects of the disclosed embodiments or examples. The summary is not a broad overview. The summary neither depicts the crucial/major component elements nor defines the scope of the examples. It is only directed to present some concepts in a concise form as an introduction to the detailed description.

In some alternative embodiments, the integrated utility based data processing method may comprise:

obtaining a first integrated utility value according to an association relationship between parameters of a cloud-based media task request and attribute parameters of current cloud-based media resources;

allocating the cloud-based media resources according to the first integrated utility value;

wherein the association relationship is obtained by calculating:

U=ω_{CR}U_{CR}^{total}(P_{CR},RT_{CR},B_{CR})+ω_{CP}U_{CP}^{total}(P_{CP},RT_{CP},B_{CP}), wherein U is the first integrated utility value; and U_{CR}^{total}(P_{CR},RT_{CR},B_{CR})≧uₘᵢₙ^{CR}, uₘᵢₙ^{CR} is the minimal utility value of the task request; and U_{CR}^{total}(P_{CR},RT_{CR},B_{CR})≧uₘᵢₙ^{CR}, uₘᵢₙ^{CR} is the minimal utility value of the resources; and ω_{CR}+ω_{CP}=1, ω_{CR} and ω_{CP} are respective weights of a second integrated utility value U_{CR}^{total}(P_{CR},RT_{CR},B_{CR}) and a third integrated utility value U_{CP}^{total}(P_{CP},RT_{CP},B_{CP});

wherein the parameters of the task request include adjustment factor P_{CR}, response time RT_{CR}, and bandwidth B_{CR}, and wherein the attribute parameters of the resources include adjustment factor P_{CP}, response time RT_{CP}, and bandwidth B_{CP}.

Another object of the present technology may relate to provide an integrated utility based data processing apparatus.

In some alternative embodiments, the integrated utility based data processing apparatus may comprise:

a service negotiation module for obtaining a first integrated utility value according to an association relationship between parameters of a cloud-based media task request and attribute parameters of current cloud-based media resources;

a resource allocation module for allocating the cloud-based resources according to the first integrated utility value;

wherein the association relationship is obtained by calculating:

U=ω_{CR}U_{CR}^{total}(P_{CR},RT_{CR},B_{CR})+ω_{CP}U_{CP}^{total}(P_{CP},RT_{CP},B_{CP}), wherein U is the first integrated utility value; and U_{CR}^{total}(P_{CR},RT_{CR},B_{CR})≧uₘᵢₙ^{CR}, uₘᵢₙ^{CR} is the minimal utility value of the task request, and U_{CP}^{total}(P_{CP},RT_{CP},B_{CP})≧uₘᵢₙ^{CP}, uₘᵢₙ^{CP} is the minimal utility value of the resources, and ω_{CR}+ω_{CP}=1, ω_{CR} and ω_{CP} are respective weights of a second integrated utility value U_{CR}^{total}(P_{CR},RT_{CR},B_{CR}) and a third integrated utility value U_{CP}^{total}(P_{CP}, RT_{CP},B_{CP});

wherein the parameters of the task request include adjustment factor P_{CR}, response time RT_{CR}, and bandwidth B_{CR}, and wherein the attribute parameters of the resources include adjustment factor P_{CP}, response time RT_{CP}, and bandwidth B_{CP}.

The technical effect according to some illustrative embodiments of the present technology may lie in that: from the view of utility improvement of cloud-based media services, when processing integrated utility based data, the objective function is no longer the minimized response time but the maximum utility of the whole cloud-based media service, and thus cloud user satisfaction can be significantly increased in the cloud resource allocation.

For the above and related objects, one or more embodiments may include the features which will be described below in detail and specifically defined by claims. The below disclosure, in connection with the drawings, illustrates some exemplary aspects of the present technology, and only indicates some of various ways in which the principles of various embodiments may be implemented. Other benefits and novelty of the present technology may become more apparent from the following detailed description, when taken in conjunction with the drawings. The disclosed embodiments are intended to include all the aspects and equivalence thereof.

### BRIEF DESCRIPTION OF THE DRAWINGS

FIG. 1 is a flowchart showing an integrated utility based data processing method according to some illustrative embodiments of the present technology.

FIG. 2 is a block diagram showing an apparatus for allocating cloud-based media resources according to some illustrative embodiments of the present technology.

FIG. 3 shows a schematic diagram comparing response times of various cloud-based media services according to some illustrative embodiments of the present technology.

FIG. 4 shows a schematic diagram comparing response times of various cloud-based media services based on different weights of the parameters according to some illustrative embodiments of the present technology.

### DETAILED DESCRIPTION

Exemplary embodiments of the present technology will be described below in sufficient detail with reference to the accompanying drawings to enable those skilled in the art to practice them, and it is to be understood that other embodiments may be utilized and that structural, logical and electrical changes may be made without departing from the described embodiments. The embodiments may only represent possible changes and modifications. Separate components and function may be optional and the order of operation may be changed, unless explicitly requested. Some parts and features of some embodiments according to the present technology may be included in or substituted by other embodiments. The scope of embodiments of the present technology includes the whole scope of claims and all the equivalence thereof obtained by claims.

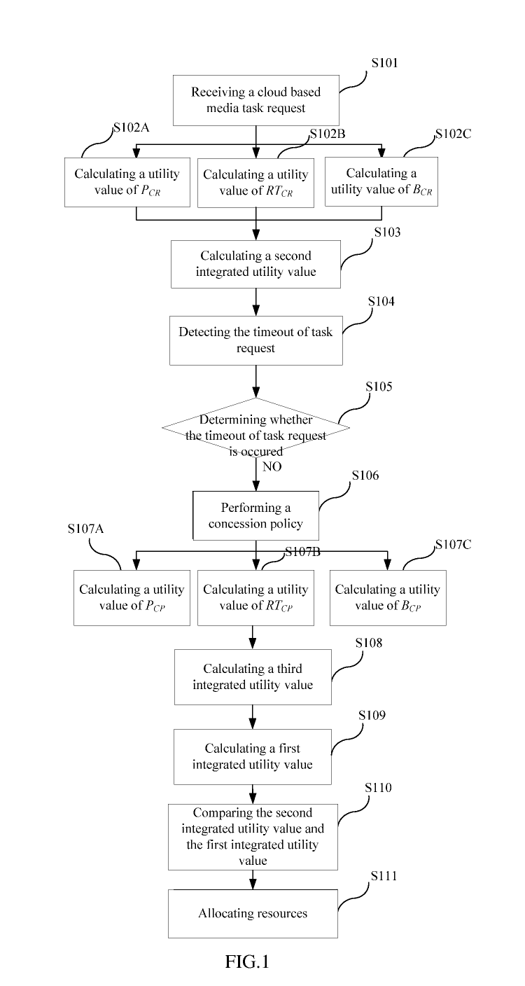

FIG. 1 shows a flowchart of a method for allocating cloud-based media resources. The method may include:

Step S109, obtaining a first integrated utility value according to an association relationship between parameters of a cloud-based media task request and attribute parameters of current cloud-based media resources;

Step S111, allocating the cloud-based media resources according to the first integrated utility value, wherein the association relationship may be obtained as follows:

U=ω_{CR}U_{CR}^{total}(P_{CR},RT_{CR},B_{CR})+ω_{CP}U_{CP}^{total}(P_{CP},RT_{CP},B_{CP}), wherein U may be the first integrated utility value; and U_{CR}^{total}(P_{CR},RT_{CR},B_{CR})≧uₘᵢₙ^{CR}, uₘᵢₙ^{CR} may be the minimum utility value of the task request; and U_{CP}^{total}(P_{CP},RT_{CP},B_{CP})≧uₘᵢₙ^{CP}, uₘᵢₙ^{CP} may be the minimal utility value of the resources; and ω_{CR}+ω_{CP}=1, ω_{CR} and ω_{CP} may be respective weights of the second integrated utility value U_{CR}^{total}(P_{CR},RT_{CR},B_{CR}) and the third integrated utility value U_{CP}^{total}(P_{CP}, RT_{CP},B_{CP});

wherein the parameters of the task request may include adjustment factor P_{CR}, response time RT_{CR}, and bandwidth B_{CR}, and the attribute parameters of the resources include adjustment factor P_{CP}, response time RT_{CP}, and bandwidth B_{CP}.

In some illustrative embodiments, the cloud-based media task request may include the following parameters: adjustment factor P_{CR}, response time RT_{CR}, and bandwidth B_{CR}. Preferably, the adjustment factor may be the price.

Since a cloud-based media service request may need to pay a cost for resources, moderate adjustment factors may well reflect the utility of cloud-based media services. Also, since a high requirement on time response for some cloud-based media services such as real time media playing, synchronization of video and audio playing and the like may be needed, such media services may be of certain timeliness. Under such circumstances reasonable response time may reflect high utility of cloud-based media services. Moreover, since the transmission of cloud-based media may need a lot of adjustment factors, a moderate bandwidth may thus increase the utility of cloud-based media services. Therefore, the adjustment factors, response time, and bandwidth for cloud-based media services may be used as a collection of the considered QoS parameters, so that the integrated utility value of a cloud-based media service may be obtained by calculating the utility value of each of the parameters to enhance the utility of a cloud-based media service.

In some illustrative embodiments, the method, before step S102, may also include step S101, receiving a cloud-based media task request.

The method may also include: step S103, calculating a second integrated utility value according to the following formula:

$${U}_{total}^{CR} ( {P}_{CR} , {RT}_{CR} , {B}_{CR} ) = \{ \begin{matrix}0 , & \begin{matrix}{U}_{P}^{CR} ( {P}_{CR} ) = 0 or {U}_{R}^{CR} ( {RT}_{CR} ) = 0 or \\ {U}_{B}^{CR} ( {B}_{CR} ) = 0\end{matrix} \\ \begin{matrix}{ω}_{P}^{CR} {U}_{P}^{CR} ( {P}_{CR} ) + {ω}_{RT}^{CR} {U}_{RT}^{CR} ( {RT}_{CR} ) + \\ {ω}_{B}^{CR} {U}_{B}^{CR} ( {B}_{CR} ) ,\end{matrix} & others\end{matrix}$$

wherein ω_{P}^{CR}+ω_{RT}^{CR}+ω_{B}^{CR}=1, ω_{P}^{CR}, ω_{RT}^{CR} and ω_{B}^{CR} may be respective weights of the utility value U_{P}^{CR}(P_{CR}) of adjustment factor P_{CR}, the utility value U_{RT}^{CR}(RT_{CR}) of response time RT_{CR}, and the utility value U_{B}^{CR}(B_{CR}) of bandwidth B_{CR} for the task request.

Before step S103, the method may further include:

Step S102A, obtaining a utility value of adjustment factor P_{CR} of the task request according to the following formula:

$${U}_{P}^{CR} ( {P}_{CR} ) = \{ \begin{matrix}{u}_{min P}^{CR} + ( 1 - {u}_{min P}^{CR} ) \cdot \vert \frac{{R}_{P}^{CR} - {P}_{CR}}{{R}_{P}^{CR} - {I}_{P}^{CR}} \vert , & {I}_{P}^{CR} \leq {P}_{CR} \leq {R}_{P}^{CR} \\ 0 , & others\end{matrix}$$

wherein u_{min P}^{CR} may represent the minimum utility value of the adjustment factor of the cloud-based media task request, I_{P}^{CR} and R_{P}^{CR} may represent the most expected adjustment factor and the least expected adjustment factor of the task request, respectively.

Step S102B, obtaining a utility value of response time RT_{CR} of the task request by calculating:

$${U}_{RT}^{CR} ( {RT}_{CR} ) = \{ \begin{matrix}{u}_{min RT}^{CR} + ( 1 - {u}_{min RT}^{CR} ) \cdot \vert \frac{{R}_{P}^{CR} - {P}_{CR}}{{R}_{P}^{CR} - {I}_{P}^{CR}} \vert , & {I}_{RT}^{CR} \leq {RT}_{CR} \leq {R}_{RT}^{CR} \\ 0 , & others\end{matrix}$$

wherein u_{min RT}^{CR} may represent the minimum utility value of the response time of the task request, I_{RT}^{CR} and R_{RT}^{CR} may represent the most expected response time and the least expected response time of the task request, respectively.

Step S102C, obtaining a utility value of the bandwidth B_{CR} of the task request according to the following formula:

$${U}_{B}^{CR} ( {B}_{CR} ) = \{ \begin{matrix}{u}_{min B}^{CR} + ( 1 - {u}_{min B}^{CR} ) \cdot \vert \frac{u ( {R}_{B}^{CR} ) - u ( {B}_{CR} )}{u ( {R}_{B}^{CR} ) - u ( {I}_{B}^{CR} )} \vert , & {I}_{B}^{CR} \leq {B}_{CR} \leq {R}_{B}^{CR} \\ 0 , & others\end{matrix}$$

wherein u_{min B}^{CR} may represent the minimum utility value of the bandwidth of the task request, and I_{B}^{CR} and R_{B}^{CR} may represent the most expected bandwidth and the least expected bandwidth and of the task request, respectively.

In some illustrative embodiments, u(B_{CR}), u(R_{B}^{CR}) and u(I_{B}^{CR}) may be obtained by the following formula:

$$U ( X ) = \{ \begin{matrix}ω log X , & {I}_{B}^{CR} \leq X \leq {R}_{B}^{CR} \\ 0 , & others\end{matrix}$$

wherein ω may represent the parameter of controlling the shape of a function, and X may be B_{CR}, R_{B}^{CR} or I_{B}^{CR}.

U_{CP}^{total}(P_{CP},RT_{CP},B_{CP}) may be obtained based on attributes of cloud-based media resources according to the following steps:

Step S108, obtaining a third integrated utility value U_{CP}^{total}(P_{CP},RT_{CP},B_{CP}) according to the formula:

$${U}_{total}^{CR} ( {P}_{CR} , {RT}_{CR} , {B}_{CR} ) = \{ \begin{matrix}0 , & \begin{matrix}{U}_{P}^{CR} ( {P}_{CR} ) = 0 or {U}_{R}^{CR} ( {RT}_{CR} ) = 0 or \\ {U}_{B}^{CR} ( {B}_{CR} ) = 0\end{matrix} \\ \begin{matrix}{ω}_{P}^{CR} {U}_{P}^{CR} ( {P}_{CR} ) + {ω}_{RT}^{CR} {U}_{RT}^{CR} ( {RT}_{CR} ) + \\ {ω}_{B}^{CR} {U}_{B}^{CR} ( {B}_{CR} ) ,\end{matrix} & others\end{matrix}$$

wherein ω_{P}^{CP}+ω_{RT}^{CP}+ω_{B}^{CP}=1, ω_{P}^{CP}, ω_{RT}^{CP}, and ω_{B}^{CP} may be respective weights of the utility value U_{P}^{CP}(P_{CP}) of the adjustment factor P_{CP}, the utility value U_{RT}^{CP}(RT_{CP}) of the response time RT_{CP} and the utility value U_{B}^{CP}(B_{CP}) of the bandwidth B_{CP} of the resources.

In some illustrative embodiments, the method, before step S108, may further include:

Step S107A, obtaining a utility value of the adjustment factor P_{CP} according to the following formula:

$${U}_{P}^{CP} ( {P}_{CP} ) = \{ \begin{matrix}{u}_{min P}^{CP} + ( 1 - {u}_{min P}^{CP} ) \cdot \vert \frac{{P}_{CP} - {P}_{P}^{CP}}{{I}_{P}^{CP} - {R}_{P}^{CP}} \vert , & {R}_{P}^{CP} \leq {P}_{CP} \leq {I}_{P}^{CP} \\ 0 , & others\end{matrix}$$

wherein u_{min P}^{CP} may represent the minimum utility value of the adjustment factor P_{CP} of the resources, and I_{P}^{CP} and R_{P}^{CP} may represent the initial adjustment factor and the reserved adjustment factor of adjustment factor P_{CP} of the resources, respectively.

Step S107B, obtaining a utility value of the response time RT_{CP} of the resources according to the following formula:

$${U}_{RT}^{CR} ( {RT}_{CP} ) = \{ \begin{matrix}{u}_{min CP}^{CP} + ( 1 - {u}_{min CP}^{CP} ) \cdot \vert \frac{{RT}_{CP} - {R}_{RT}^{CP}}{{I}_{RT}^{CP} - {R}_{RT}^{CP}} \vert , & {R}_{RT}^{CP} \leq {RT}_{CP} \leq {I}_{RT}^{CP} \\ 0 , & others\end{matrix}$$

wherein u_{min RT}^{CP} may represent the minimum utility value of the response time of the resources, I_{RT}^{CP} and R_{RT}^{CP} may represent the initial response time and the reserved response time of the resources.

Step S107c, obtaining a utility value of bandwidth B_{CP} according to the following formula:

$${U}_{B}^{CP} ( {B}_{CP} ) = \{ \begin{matrix}{u}_{min B}^{CP} + ( 1 - {u}_{min B}^{CP} ) \cdot \vert \frac{{B}_{CP} - {R}_{B}^{cp}}{{I}_{B}^{CP} - {R}_{B}^{CP}} \vert , & {R}_{B}^{CP} \leq {B}_{CP} \leq {I}_{B}^{CP} \\ 0 , & others\end{matrix}$$

wherein u_{min B}^{CP} may represent the minimum utility value of the bandwidth of the resources, and I_{B}^{CP} and R_{B}^{CP} may represent the initial bandwidth and the reserved bandwidth of the resources, respectively.

In some illustrative embodiments, the method, before step S111, may include: Step S110, comparing the second integrated utility value with the first integrated utility value.

In some illustrative embodiments, step S111 may include allocating the current cloud-based media resources to the cloud-based media task request if the first integrated utility value is not less than the second integrated utility value.

In some illustrative embodiments, step S111 may also include: if there are a plurality of cloud-based media resources, the cloud-based task request corresponding to a plurality of first integrated utility values, and each of the plurality of first integrated utility values corresponding to a cloud-based media resource; while, if the maximum value of the plurality of first integrated utility values is not less than the second integrated utility value, allocating the cloud-based media resource corresponding to the maximum first integrated utility value to the cloud-based media task request.

In some illustrative embodiments, the method, after step S103, may also include:

Step S104, detecting the timeout of the task request if the second integrated utility value is zero;

Step S105, determining whether the timeout of the task request occurs;

If the timeout of the task request is determined, the allocating of the cloud-based media resources may end; if no timeout is determined, repeatedly determining the second integrated utility value by executing a concession policy until the second integrated utility value is not zero.

Step 106, executing the concession policy may further include:

obtaining the second integrated utility value of a next task request based on the second integrated utility of the current task request according to the following formula:

Uₜₒₜₐₗ^{CR}(P_{CR},RT_{CR},B_{CR})ₜ₊₁=Uₜₒₜₐₗ^{CR}(P_{CR},RT_{CR},B_{CR})ₜ−ΔUₜₒₜₐₗ^{CR}

wherein Uₜₒₜₐₗ^{CR}(P_{CR},RT_{CR},B_{CR})ₜ may be the second integrated utility value of the current task request and ΔUₜₒₜₐₗ^{CR} may be a step size of concessions.

If the second integrated utility value of the next task request is not zero, subsequent steps may be carried out.

In some illustrative embodiments, the step size of concessions may be obtained according to the following formula:

$$Δ {u}_{total} = {U}_{total}^{t} \cdot {( \frac{t}{τ} )}^{λ}$$

wherein τ may be the cut-off time (the maximum number of negotiations may be determined based on τ), t may be the number of negotiations, and λ may be the parameter of controlling concession rates, 0≦λ≦10.

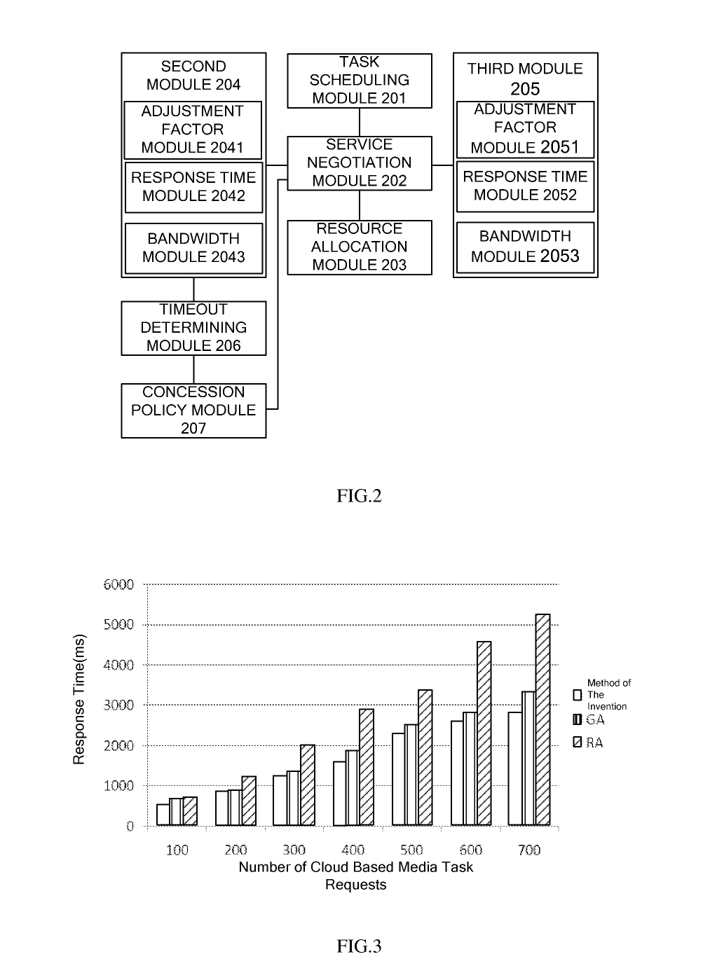

With respect to the foregoing method, the present technology may also provide an apparatus for allocating cloud-based media resources. As shown in FIG. 2, the apparatus may comprise:

a service negotiation module 202 for obtaining a first integrated utility value according to an association relationship between parameters of a cloud-based media task request and attribute parameters of current cloud-based media resources.

a resource allocation module 203 for allocating the cloud-based media resources according to the first integrated utility value;

wherein the association relationship may be calculated according to the following formula:

U=ω_{CR}U_{CR}^{total}(P_{CR},RT_{CR},B_{CR})ω_{CP}U_{CP}^{total}(P_{CP},RT_{CP},B_{CP})

wherein U may be the first integrated utility value; and U_{CR}^{total}(P_{CR},RT_{CR},B_{CR})≧uₘᵢₙ^{CR}, uₘᵢₙ^{CR} may be the minimum utility value of the task request; and U_{CP}^{total}(P_{CP},RT_{CP},B_{CP})≧uₘᵢₙ^{CP}, uₘᵢₙ^{CP} may be the minimum utility value of the resources; and ω_{CR}+ω_{CP}=1, ω_{CR} and ω_{CP} may be respective weights of the second integrated utility value U_{CR}^{total}(P_{CR},RT_{CR},B_{CR}) and the third integrated utility value U_{CP}^{total}(P_{CP},RT_{CP},B_{CP}); and wherein the parameters of the task request may include adjustment factor P_{CR}, response time RT_{CR} and bandwidth B_{CR}, and the attribute parameters of the resources may include adjustment factor P_{CP}, response time RT_{CP} and bandwidth B_{CP}.

From the view of improving cloud-based media service utility, the objective function for the apparatus may be no longer the minimized response time but the maximized utility in a cloud computing environment to greatly increase satisfaction of cloud users.

In some illustrative embodiments, the cloud-based media task request may include the following parameters: adjustment factor P_{CR}, response time RT_{CR} and bandwidth B_{CR}.

Since a cloud-based media service request may need to pay a cost for resources, a moderate adjustment factor may well reflect the utility of a cloud-based media service. Also, since a high requirement on time response for some cloud-based media services such as real time media playing, synchronization of video and audio playing and the like may be needed, such media services may be of certain timeliness. Under such circumstances reasonable response time may reflect high utility of cloud-based media services. Moreover, the transmission of cloud-based media may need a lot of adjustment factors, and a moderate bandwidth may thus increase the utility of cloud-based media services. Therefore, the adjustment factors, response time, and bandwidth for cloud-based media services may be used as a collection of the considered QoS parameters, so that the integrated utility value of a cloud-based media service may be obtained by calculating the utility value of each of the parameters to enhance the utility of a cloud-based media service.

In some illustrative embodiments, the apparatus may also include a second module 204 for calculating a second integrated utility value.

In some illustrative embodiments, the second module 204 may calculate the second integrated utility value as follows:

$${U}_{total}^{CR} ( {P}_{CR} , {RT}_{CR} , {B}_{CR} ) = \{ \begin{matrix}0 , & \begin{matrix}{U}_{P}^{CR} ( {P}_{CR} ) = 0 or {U}_{R}^{CR} ( {RT}_{CR} ) = 0 or \\ {U}_{B}^{CR} ( {B}_{CR} ) = 0\end{matrix} \\ \begin{matrix}{ω}_{P}^{CR} {U}_{P}^{CR} ( {P}_{CR} ) + {ω}_{RT}^{CR} {U}_{RT}^{CR} ( {RT}_{CR} ) + \\ {ω}_{B}^{CR} {U}_{B}^{CR} ( {B}_{CR} ) ,\end{matrix} & others\end{matrix}$$

wherein ω_{P}^{CR}+ω_{RT}^{CR}+ω_{B}^{CR}=1, and ω_{P}^{CR}, ω_{RT}^{CR}, and ω_{B}^{CR} may be respective weights of the utility value U_{P}^{CR}(P_{CR}) of the adjustment factor P_{CR}, the utility value U_{RT}^{CR}(RT_{CR}) of the response time RT_{CR}, and the utility value U_{B}^{CR}(B_{CR}) of the bandwidth B_{CR} of the task request.

In some illustrative embodiments, the second module 204 may further include an adjustment factor module for task requests 2041, a response time module for task requests 2042, and a bandwidth module for task requests 2043.

The adjustment factor module for task requests 2041 may calculate a utility value of the adjustment factor P_{CR} of the task quest according to the following formula:

$${U}_{P}^{CR} ( {P}_{CR} ) = \{ \begin{matrix}{u}_{min P}^{CR} + ( 1 - {u}_{min P}^{CR} ) \cdot \vert \frac{{R}_{P}^{CR} - {P}_{CR}}{{R}_{P}^{CR} - {I}_{P}^{CR}} \vert , & {I}_{P}^{CR} \leq {P}_{CR} \leq {R}_{P}^{CR} \\ 0 , & others\end{matrix}$$

wherein u_{min P}^{CR} may represent the minimum utility value of the adjustment factor of the task request, I_{P}^{CR} and R_{P}^{CR} may represent the most expected adjustment factor and the least expected adjustment factor of the task request, respectively.

The response time module for task requests 2042 may calculate a utility value of the response time RT_{CR} of the task request as follows:

$${U}_{RT}^{CR} ( {RT}_{CR} ) = \{ \begin{matrix}{u}_{min RT}^{CR} + ( 1 - {u}_{min RT}^{CR} ) \cdot \vert \frac{{R}_{RT}^{CR} - {RT}_{CR}}{{R}_{RT}^{CR} - {I}_{RT}^{CR}} \vert , & {I}_{RT}^{CR} \leq {RT}_{CR} \leq {R}_{RT}^{CR} \\ 0 , & others\end{matrix}$$

wherein u_{min RT}^{CR} may represent the minimum utility value of the response time of the task request, I_{RT}^{CR} and R_{RT}^{CR} may represent the most expected response time and the least expected response time of a task request, respectively.

The bandwidth module for task requests 2043 may calculate the utility value of the bandwidth B_{CR} of the task request according to the following formula:

$${U}_{B}^{CR} ( {B}_{CR} ) = \{ \begin{matrix}{u}_{min B}^{CR} + ( 1 - {u}_{min B}^{CR} ) \cdot \vert \frac{u ( {R}_{B}^{CR} ) - u ( {B}_{CR} )}{u ( {R}_{B}^{CR} ) - u ( {I}_{B}^{CR} )} \vert , & {I}_{B}^{CR} \leq {B}_{CR} \leq {R}_{B}^{CR} \\ 0 , & others\end{matrix}$$

wherein u_{min B}^{CR} may represent the minimum utility value of the task request, and I_{B}^{CR} and R_{B}^{CR} may represent the most expected bandwidth and the least expected bandwidth of the task request, respectively.

In some illustrative embodiments, u(B_{CR}), u(R_{B}^{CR}) and u(I_{B}^{CR}) may be obtained by the following formula:

$$u ( X ) = \{ \begin{matrix}ω log X , & {I}_{B}^{CR} \leq X \leq {R}_{B}^{CR} \\ 0 , & others\end{matrix}$$

wherein ω may represent the parameter of controlling the shape of a function, and X may be B_{CR}, R_{B}^{CR} or I_{B}^{CR}.

In some illustrative embodiments, the apparatus may also include a third module 205. The third module 205 may obtain a third integrated utility value U_{CP}^{total}(P_{CP},RT_{CP},B_{CP}) according to the following formula:

$${U}_{total}^{CP} ( {P}_{CP} , {RT}_{CP} , {B}_{CP} ) = \{ \begin{matrix}0 , & \begin{matrix}{U}_{P}^{CP} ( {P}_{CP} ) = 0 or {U}_{RT}^{CP} ( {RT}_{CP} ) = 0 \\ or {U}_{B}^{CP} ( {B}_{CP} ) = 0\end{matrix} \\ \begin{matrix}{ω}_{P}^{CP} {U}_{P}^{CP} ( {P}_{CP} ) + {ω}_{RT}^{CP} {U}_{RT}^{CP} ( {RT}_{CP} ) + \\ {ω}_{B}^{CP} {U}_{B}^{CP} ( {B}_{CP} )\end{matrix} , & others\end{matrix}$$

wherein ω_{P}^{CP}+ω_{RT}^{CP}+ω_{B}^{CP}=1, ω_{P}^{CP}, ω_{RT}^{CP}, and ω_{B}^{CP} may be respective weights of the utility value U_{P}^{CP}(P_{CP}) of the adjustment factor P_{CP}, the utility value U_{RT}^{CP}(RT_{CP}) of the response time RT_{CP} and the utility value U_{B}^{CP}(B_{CP}) of the bandwidth B_{CP} of the resources.

In some illustrative embodiments, the third module 205 may further include an adjustment factor module for resources 2051, a response time module for resources 2052, and a bandwidth module for resources 2053.

The adjustment factor module for resources 2051 may calculate a utility value of the adjustment factor P_{CP} of the resources according to the following formula:

$${U}_{P}^{CP} ( {P}_{CP} ) = \{ \begin{matrix}{u}_{min CP}^{CP} + ( 1 - {u}_{min CP}^{CP} ) \cdot \vert \frac{{P}_{CP} - {R}_{P}^{CP}}{{I}_{P}^{CP} - {R}_{P}^{CP}} \vert , & {R}_{P}^{CP} \leq {P}_{CP} \leq {I}_{P}^{CP} \\ 0 , & others\end{matrix}$$

wherein u_{min P}^{CP} may represent the minimum utility value of the adjustment factor P_{CP} of the resources, and I_{P}^{CP} and R_{P}^{CP} may represent the initial adjustment factor and the reserved adjustment factor of the adjustment factor P_{CP} of the resources, respectively.

The response time module for resources 2052 may calculate a utility value of the response time RT_{CP} of the resources according to the following formula:

$${U}_{RT}^{CP} ( {RT}_{CP} ) = \{ \begin{matrix}{u}_{min CP}^{CP} + ( 1 - {u}_{min CP}^{CP} ) \cdot \vert \frac{{RT}_{CP} - {R}_{RT}^{CP}}{{I}_{RT}^{CP} - {R}_{RT}^{CP}} \vert , & {R}_{RT}^{CP} \leq {RT}_{CP} \leq {I}_{RT}^{CP} \\ 0 , & others\end{matrix}$$

wherein u_{min RT}^{CP} may represent the minimum utility value of the response time of the resources, I_{RT}^{CP} and R_{RT}^{CP} may represent the initial response time and the reserved response time of the resources, respectively.

The bandwidth module for resources 2053 may calculate a utility value of bandwidth B_{CP} of the resources according to the following formula:

$${U}_{B}^{CP} ( {B}_{CP} ) = \{ \begin{matrix}{u}_{min B}^{CP} + ( 1 - {u}_{min B}^{CP} ) \cdot \vert \frac{{B}_{CP} - {R}_{B}^{CP}}{{I}_{B}^{CP} - {R}_{B}^{CP}} \vert , & {R}_{B}^{CP} \leq {B}_{CP} \leq {I}_{B}^{CP} \\ 0 , & others\end{matrix}$$

wherein u_{min B}^{CP} may represent the minimum utility value of the bandwidth of resources, and I_{B}^{CP} and R_{B}^{CP} may represent the initial bandwidth and the reserved bandwidth of resources, respectively.

In some illustrative embodiments, the apparatus may also include a task scheduling module 201 for receiving a cloud-based media task request.

In some illustrative embodiments, if a service negotiation module 202 determines that the first integrated utility value is not less than the second integrated utility, a resource allocation module 203 may allocate a current cloud-based media resource to the cloud-based task media request.

In some illustrative embodiments, if there are a plurality of cloud-based media resources, the cloud-based media task request may then correspond to a plurality of first integrated utility values, each of the plurality of first integrated utility values corresponding to a cloud-based media resource. If the service negotiation module 202 determines that the maximum of the plurality of first integrated utility values is not less than the second integrated utility value, the resource allocation module 203 may then allocate the cloud-based media resource corresponding to the maximum to the cloud-based media task request.

In some illustrative embodiments, the apparatus may also include a timeout determining module 206 for detecting a timeout of the task request if the second integrated utility value is zero. If the timeout is determined, the allocation of the cloud-based media resources may then end. If no timeout has occurred, a concession policy may be executed.

In some illustrative embodiments, the apparatus may also include a concession policy module 207. The concession policy module 207 may repeatedly determine the second integrated utility until the second integrated utility is not zero.

In some illustrative embodiments, an execution of the concession policy as performed by the concession policy module 207 may include obtaining the second integrated utility of the next task request based on the second integrated utility of the current task request according to the following formula:

Uₜₒₜₐₗ^{CR}(P_{CR},RT_{CR},B_{CR})ₜ₊₁=Uₜₒₜₐₗ^{CR}(P_{CR},RT_{CR},B_{CR})ₜ−ΔUₜₒₜₐₗ^{CR}

wherein Uₜₒₜₐₗ^{CR}(P_{CR},RT_{CR},B_{CR})ₜ₊₁ may be the second integrated utility value of the current task request, and ΔUₜₒₜₐₗ^{CR} may be a step size of concessions.

In some illustrated examples, the step size of concessions may be obtained according to the following formula:

$$Δ {U}_{total} = {U}_{total}^{t} \cdot {( \frac{t}{τ} )}^{λ}$$

wherein τ may be the cut-off time (the maximum number of negotiations may be determined based on τ), and t may be the number of negotiations, and λ may be the parameter of controlling concession rates, 0≦λ≦10.

A simulated example will be described below to further illustrate methods of the present technology. In the simulated example, on the simulation platform CloudSim as the simulation environment, the performance of Greedy Allocation algorithm, Random Allocation Algorithm and the method provided by the present technology may all be evaluated by utilizing the parameters of the cloud-based media task request and the attribute parameters of cloud-based media resources as inputs.

(1) Setting Simulation Parameters

In the simulation example, the algorithms may be evaluated by increasing the number of cloud-based media task requests from 100 to 700, wherein the parameters for task requests may be randomly generated within certain limits by the simulation platform. The generated random numbers may satisfy the following condition:

$$P \leq α \cdot \frac{{S}_{e} + {S}_{o}}{B \times RT}$$

wherein Sₑ and Sₒ may represent the size of the executable job files of a cloud-based media task request and the size of the result files to be transmitted after execution, respectively, and α may be the corresponding coefficient, 0≦α≦1. The relationship of the adjustment factor, the response time and the bandwidth of cloud-based media services may be reflected by way of setting α. The attributes of cloud-based media resources may be divided into different levels, corresponding to different ranges of the adjustment factor, the response time, and the bandwidth. The setting of the parameters may meet the above formula, and other parameters may be set as shown in Table 1. In the example, price may be used as the adjustment factor.

TABLE 1
Setting of other parameters

| Parameters | Parameter settings |
|---|---|
| τ | 10 |
| U | U = (Uₜₒₜₐₗ^{CR} (P_{CR}, RT_{CR}, B_{CR}) + Uₜₒₜₐₗ^{CP})/2 |
| | ω_{CR} and ω_{CP} each are 0.5 |
| Uₜₒₜₐₗ^{CR} | (Uₜₒₜₐₗ^{CR} (P_{CR}, RT_{CR}, B_{CR}) = ω_{P}^{CR}U_{P}^{CR} (P_{CR}) + |
| (P_{CR}, RT_{CR}, B_{CR}) | ω_{RT}^{CR}U_{RT}^{CR} (RT_{CR}) + ω_{B}^{CR}U_{B}^{CR} (B_{CR}) |
| | ω_{P}^{CR}, ω_{RT}^{CR} and ω_{B}^{CR} each are ⅓ |
| Uₜₒₜₐₗ^{CP} | (Uₜₒₜₐₗ^{CP} (P_{CP}, RT_{CP}, B_{CP}) = ω_{P}^{CP}U_{P}^{CP} (P_{CP}) + |
| (P_{CP}, RT_{CP}, B_{CP}) | ω_{RT}^{CP}U_{RT}^{CP} (RT_{CP}) + ω_{B}^{CP}U_{B}^{CP} (B_{CP}) |
| | ω_{P}^{CP}, ω_{RT}^{CP} and ω_{B}^{CP} each are ⅓ |
| α | 1.2 |

(2) Response Time Analysis of Cloud-Based Media Services

The performance of the overall cloud-based media resource allocation may be evaluated by the execution time of services. In the simulation example, the execution time of cloud-based media services may be thus analyzed. The execution time may be defined by

$$Time = {\sum }_{i = 1}^{n} tim {\dot{e}}_{i}$$

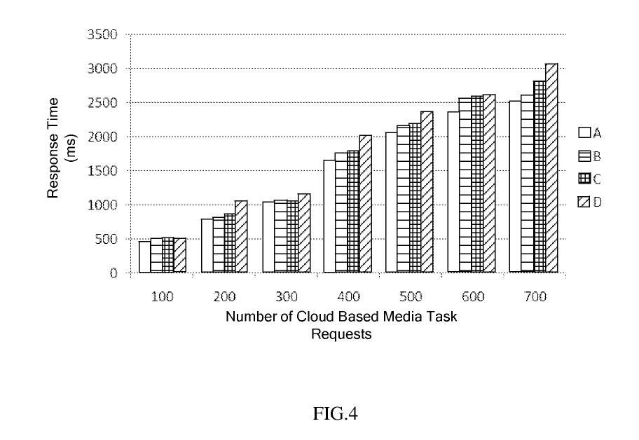

The number of cloud-based media resource requests may be increased from 100 to 700. In the algorithm of the present technology, the response time and the transmission bandwidth may be used as the parameters of the cloud-based media resource allocation, and the maximum utility values of the parameters may be selected, achieving a good effect of service response time. The specific simulation results are shown as FIG. 3. FIG. 3 exhibits that, at the beginning of cloud-based media services, sufficient resources serve a relatively small number of task requests, and thus the response times of three methods may be substantially the same. As the number of task requests is increasing, the present technology shows well stability and the response times of the present technology are superior to that of two other algorithms.

(3) Utility Analysis of Cloud-Based Media Services

The utility values of cloud-based media services may reflect the satisfaction ratings of cloud-based media services. The number of cloud-based media task request may be increased from 100 to 700 for analyzing the utility values of cloud-based services. In the present technology, the maximum utility of the cloud-based media resource allocation may be obtained by calculating the utilities of the parameters, thus achieving good utility values of cloud-based media services. Table 2 shows the simulation results.

TABLE 2
Comparison of cloud-based media service utilities

| | | | | | | | |
|---|---|---|---|---|---|---|---|
| The present | 0.51 | 0.51 | 0.52 | 0.50 | 0.50 | 0.51 | 0.51 |
| method | | | | | | | |
| GA | 0.31 | 0.29 | 0.29 | 0.30 | 0.29 | 0.30 | 0.31 |
| RA | 0.23 | 0.24 | 0.28 | 0.30 | 0.30 | 0.3 | 0.30 |

Table 2 exhibits that, as the number of cloud-based media services increases, the utility values of cloud-based media services provided by the present method may be higher than the other two algorithms, which well meets Service Level Agreements and thus improves satisfaction of cloud-based media services.

(4) Analysis of Different Weight Values of Negotiation Parameters Used in the Present Technology

The weight values of the price, the response time and the bandwidth of cloud-based media services may be set respectively. Table 3 shows the set weight values.

TABLE 3
different weight values of cloud-based media services

| Combinations of | | | |
|---|---|---|---|
| different weight | | | |
| values | ω_{P}^{CR}, ω_{P}^{CP} | ω_{RT}^{CR}, ω_{RT}^{CP} | ω_{B}^{CR}, ω_{B}^{CP} |
| A | 0.2 | 0.6 | 0.2 |
| B | 0.2 | 0.4 | 0.4 |
| C | 0.4 | 0.4 | 0.2 |
| D | 0.4 | 0.2 | 0.4 |

FIG. 4 and Table 4 respectively illustrate response times and utility values of cloud-based media services based on different weight values according to the method of the present technology. As shown in FIG. 4, the response time may be decreased with increasing the weight of the response time. Table 4 exhibits that the total utility values obtained according to the method of the present technology may be relatively stable although the weight values of the parameters are changed, which demonstrates well stability of the present technology.

TABLE 4
Comparison of utility values of cloud-based media services
under different weight values of negotiation parameters

| | number of task requests | | | | | | |
|---|---|---|---|---|---|---|---|
| weight | 100 | 200 | 300 | 400 | 500 | 600 | 700 |
| A | 0.59 | 0.58 | 0.59 | 0.59 | 0.59 | 0.59 | 0.59 |
| B | 0.56 | 0.56 | 0.57 | 0.55 | 0.57 | 0.56 | 0.58 |
| C | 0.52 | 0.55 | 0.54 | 0.54 | 0.53 | 0.54 | 0.55 |
| D | 0.51 | 0.53 | 0.51 | 0.53 | 0.52 | 0.49 | 0.51 |

In conclusion, high utility values of services may be obtained by allocating cloud-based media resources according to the method of the present technology, and thus SLAs may be better met and higher service level may be realized, improving satisfaction of cloud-based media services.

It should be readily understood by those skilled in the art that various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software may depend upon the particular application and design constraints imposed on the overall system. Skilled artisans may implement the described functionality in varying ways for each particular application, but such implementation decisions should not be interpreted as causing a departure from the scope of the present technology.

What is claimed is:

1. A method for processing integrated utility based data, comprising:
obtaining a first integrated utility value according to an association relationship between parameters of a cloud-based media task request and attribute parameters of a cloud-based media resource;
allocating the cloud-based media resource according to the first integrated utility value, wherein the association relationship is calculated as follows:
U=ω_{CR}U_{CR}^{total}(P_{CR},RT_{CR},B_{CR})+ω_{CP}U_{CP}^{total}(P_{CP},RT_{CP},B_{CP}), wherein U is the first integrated utility value; and U_{CR}^{total}(P_{CR},RT_{CR},B_{CR})≧uₘᵢₙ^{CR}, uₘᵢₙ^{CR} is a minimum utility value of the task request; and U_{CP}^{total}(P_{CP},RT_{CP},B_{CP})≧uₘᵢₙ^{CP}, uₘᵢₙ^{CP} is a minimum utility value of the resources; and ω_{CR}+ω_{CP}=1, ω_{CR} and ω_{CP} are respective weights of a second integrated utility value U_{CR}^{total}(P_{CR},RT_{CR},B_{CR}) and a third integrated utility value U_{CP}^{total}(P_{CP},RT_{CP},B_{CP}), and
wherein the parameters of the task request include adjustment factor P_{CR}, response time RT_{CR}, and a bandwidth B_{CR}, and wherein the attribute parameters of the resources include an adjustment factor P_{CP}, a response time RT_{CP}, and a bandwidth B_{CP}.

2. The method of claim 1, wherein the second integrated utility value is calculated according to the following formula:
$${U}_{total}^{CR} ( {P}_{CR} , {RT}_{CR} , {B}_{CR} ) = \{ \begin{matrix}0 , & \begin{matrix}{U}_{P}^{CR} ( {P}_{CR} ) = 0 or {U}_{RT}^{CR} ( {RT}_{CR} ) = 0 \\ or {U}_{B}^{CR} ( {B}_{CR} ) = 0\end{matrix} \\ \begin{matrix}{ω}_{P}^{CR} {U}_{P}^{CR} ( {P}_{CR} ) + {ω}_{RT}^{CR} {U}_{RT}^{CR} ( {RT}_{CR} ) + \\ {ω}_{B}^{CR} {U}_{B}^{CR} ( {B}_{CR} )\end{matrix} , & others\end{matrix}$$
where ω_{P}^{CR}+ω_{RT}^{CR}+ω_{B}^{CR}=1, ω_{P}^{CR}, ω_{RT}^{CR}, and ω_{B}^{CR} are respective weights of a utility value U_{P}^{CR}(P_{CR}) of the adjustment factor P_{CR}, a utility value U_{RT}^{CR}(RT_{CR}) of the response time RT_{CR}, and a utility value U_{B}^{CR}(B_{CR}) of the bandwidth B_{CR} of the task request.

3. The method of claim 2, wherein the utility value of the adjustment factor P_{CR} of the task request is calculated by the following formula:
$${U}_{P}^{CR} ( {P}_{CR} ) = \{ \begin{matrix}{u}_{min P}^{CR} + ( 1 - {u}_{min P}^{CR} ) \cdot \vert \frac{{R}_{P}^{CR} - {P}_{CR}}{{R}_{P}^{CR} - {I}_{P}^{CR}} \vert , & {I}_{P}^{CR} \leq {P}_{CR} \leq {R}_{P}^{CR} \\ 0 , & others\end{matrix}$$
where u_{min P}^{CR} represents a minimum utility value of the adjustment factor of the cloud-based media task request, I_{P}^{CR} and R_{P}^{CR} represent a most expected adjustment factor and a least expected adjustment factor of the task request, respectively;
wherein the utility value of the response time RT_{CR} of the task request is calculated by the following formula:
$${U}_{RT}^{CR} ( {RT}_{CR} ) = \{ \begin{matrix}{u}_{min RT}^{CR} + ( 1 - {u}_{min RT}^{CR} ) \cdot \vert \frac{{R}_{RT}^{CR} - {RT}_{CR}}{{R}_{RT}^{CR} - {I}_{RT}^{CR}} \vert , & {I}_{RT}^{CR} \leq {RT}_{CR} \leq {R}_{RT}^{CR} \\ 0 , & others\end{matrix}$$
where u_{min RT}^{CR} represents a minimum utility value of the response time of the task request, I_{RT}^{CR} and R_{RT}^{CR} represent a most expected response time and a least expected response time of the task request, respectively; and
wherein the utility value of bandwidth B_{CR} of the task request is calculated by the following formula:
$${U}_{B}^{CR} ( {B}_{CR} ) = \{ \begin{matrix}{u}_{min B}^{CR} + ( 1 - {u}_{min B}^{CR} ) \cdot \vert \frac{u ( {R}_{B}^{CR} ) - u ( {B}_{CR} )}{u ( {R}_{B}^{CR} ) - u ( {I}_{B}^{CR} )} \vert , & {I}_{B}^{CR} \leq {B}_{CR} \leq {R}_{B}^{CR} \\ 0 , & others\end{matrix}$$
where u_{min B}^{CR} represents a minimum utility value of the bandwidth of the task request, and I_{B}^{CR} and R_{B}^{CR} represent a most expected bandwidth and a least expected bandwidth of the task request, respectively.

4. The method of claim 3, wherein u(B_{CR}), u(R_{B}^{CR}) and u(I_{B}^{CR}) are obtained by the following formula:
$$u ( X ) = \{ \begin{matrix}ω log X , & {I}_{B}^{CR} \leq X \leq {R}_{B}^{CR} \\ 0 , & others\end{matrix}$$
where ω represents a parameter for controlling a function shape, and X is B_{CR}, R_{B}^{CR} or I_{B}^{CR}.

5. The method of claim 1, wherein the third integrated utility value U_{CP}^{total}(P_{CP},RT_{CP},B_{CP}) is obtained according to the following formula:
$${U}_{total}^{CP} ( {P}_{CP} , {RT}_{CP} , {B}_{CP} ) = \{ \begin{matrix}0 , {U}_{P}^{CP} ( {P}_{CP} ) = 0 or {U}_{RT}^{CP} ( {RT}_{CP} ) = 0 or {U}_{B}^{CP} ( {B}_{CP} ) = 0 \\ {ω}_{P}^{CP} {U}_{P}^{CP} ( {P}_{CP} ) + {ω}_{RT}^{CP} {U}_{RT}^{CP} ( {RT}_{CP} ) + {ω}_{B}^{CP} {U}_{B}^{CP} ( {B}_{CP} ) , others\end{matrix}$$
where ω_{P}^{CP}+ω_{RT}^{CP}+ω_{B}^{CP}=1, ω_{P}^{CP}, ω_{RT}^{CP}, and ω_{B}^{CP} are respective weights of a utility value U_{P}^{CP}(P_{CP}) of the adjustment factor P_{CP}, a utility value U_{RT}^{CP}(RT_{CP}) of the response time RT_{CP} and a utility value U_{B}^{CP}(B_{CP}) of the bandwidth B_{CP}.

6. The method of claim 5, wherein the utility value of the adjustment factor P_{CP} of the resource is calculated by the following formula:
$${U}_{P}^{CP} ( {P}_{CP} ) = \{ \begin{matrix}{u}_{m i nCP}^{CP} + ( 1 - {u}_{m i nCP}^{CP} ) \cdot \vert \frac{{P}_{CP} - {R}_{P}^{CP}}{{I}_{P}^{CP} - {R}_{P}^{CP}} \vert , {R}_{P}^{CP} \leq {P}_{CP} \leq {I}_{P}^{CP} \\ 0 , others\end{matrix}$$
where u_{min P}^{CP} represents a minimum utility value of the adjustment factor P_{CP} of the resource, and I_{P}^{CP} and R_{P}^{CP} represent an initial adjustment factor and a reserved adjustment factor of the adjustment factor P_{CP} of the resource, respectively;
wherein the utility value of the response time RT_{CP} of the resource is calculated by the following formula:
$${U}_{RT}^{CP} ( {RT}_{CP} ) = \{ \begin{matrix}{u}_{m i nCP}^{CP} + ( 1 - {u}_{m i nCP}^{CP} ) \cdot \vert \frac{{RT}_{CP} - {R}_{RT}^{CP}}{{I}_{RT}^{CP} - {R}_{RT}^{CP}} \vert , {R}_{RT}^{CP} \leq {RT}_{CP} \leq {I}_{RT}^{CP} \\ 0 , others\end{matrix}$$
where u_{min RT}^{CP} represents a minimum utility value of the response time of the resource, I_{RT}^{CP} and R_{RT}^{CP} represent an initial response time and a reserved response time of the resource, respectively; and
wherein the utility value of the bandwidth B_{CP} is calculated by the following formula:
$${U}_{B}^{CP} ( {B}_{CP} ) = \{ \begin{matrix}{u}_{m i nB}^{CP} + ( 1 - {u}_{m i nB}^{CP} ) \cdot \vert \frac{{B}_{CP} - {R}_{B}^{CP}}{{I}_{B}^{CP} - {R}_{B}^{CP}} \vert , {R}_{B}^{CP} \leq {B}_{CP} \leq {I}_{B}^{CP} \\ 0 , others\end{matrix}$$
where U_{min B}^{CP} represents a minimum utility value of the bandwidth of the resource, and I_{B}^{CP} and R_{B}^{CP} represent an initial bandwidth and a reserved bandwidth of the resources, respectively.

7. The method of claim 1, further comprising:
receiving the cloud-based media service request;
comparing the second integrated utility value with the first integrated utility value; and
allocating the cloud-based media resource to the cloud-based media task request when the first integrated utility value is not less than the second integrated utility value.

8. The method of claim 7, further comprising:
corresponding the cloud-based task request to a plurality of first integrated utility values when there are a plurality of cloud-based media resources, each of the plurality of first integrated utility values corresponding to a cloud-based media resource; and
if a maximum first integrated utility value is not less than the second integrated utility value, allocating the cloud-based media resource that corresponds to the maximum first integrated utility value to the cloud-based media task request.

9. The method of claim 7, further comprising:
detecting a timeout of the task request when the second integrated utility value is zero.

10. The method of claim 9, wherein the allocating of the cloud-based media resource ends when the timeout is detected.

11. The method of claim 10, further comprising repeatedly determining the second integrated utility value by executing a concession policy until the second integrated utility value is not zero, when the timeout is not detected.

12. The method of claim 11, wherein the executing of the concession policy includes:
obtaining a second integrated utility value of a next task request based on a second integrated utility of a current task request by the following formula:
Uₜₒₜₐₗ^{CR}(P_{CR},RT_{CR},B_{CR})ₜ₊₁=Uₜₒₜₐₗ^{CR}(P_{CR},RT_{CR},B_{CR})ₜ−ΔUₜₒₜₐₗ^{CR}
wherein Uₜₒₜₐₗ^{CR}(P_{CR},RT_{CR},B_{CR})ₜ is the second integrated utility value of the current task request and ΔUₜₒₜₐₗ^{CR} is a step size of concessions.

13. The method of claim 12, wherein the step size of concessions is determined according to the following formula:
$$Δ {U}_{total} = {U}_{total}^{t} \cdot {( \frac{t}{τ} )}^{λ}$$
where τ is a cut-off time, t is a number of negotiations, and λ is a parameter for controlling a concession rate, 0≦λ≦10.

14. An apparatus for processing integrated utility based data, comprising:
a service negotiation module for obtaining a first integrated utility value according to an association relationship between parameters of a cloud-based media task request and attribute parameters of a cloud-based media resource;
a resource allocation module for allocating the cloud-based media resource according to the first integrated utility value,
wherein the association relationship is calculated as follows:
U=ω_{CR}U_{CR}^{total}(P_{CR},RT_{CR},B_{CR})ω_{CP}U_{CP}^{total}(P_{CP},RT_{CP},B_{CP}),
where U is the first integrated utility value; and U_{CR}^{total}(P_{CR},RT_{CR},B_{CR})≧uₘᵢₙ^{CR}, uₘᵢₙ^{CR} is a minimum utility value of the task request; and U_{CP}^{total}(P_{CP},RT_{CP},B_{CP})≧uₘᵢₙ^{CP}, uₘᵢₙ^{CP} is a minimum utility value of the resource; and ω_{CR}+ω_{CP}=1, ω_{CR} and ω_{CP} are respective weights of a second integrated utility value U_{CR}^{total}(P_{CR},RT_{CR},B_{CR}) and a third integrated utility value U_{CP}^{total}(P_{CP},RT_{CP},B_{CP});
wherein the parameters of the task request include an adjustment factor P_{CR}, a response time RT_{CR}, and a bandwidth B_{CR}, and wherein the attribute parameters of the resource include an adjustment factor P_{CP}, a response time RT_{CP}, and a bandwidth B_{CP}.

15. The apparatus according to claim 14, further comprising:
a second module for calculating the second integrated utility value according to the following formula:
$${U}_{total}^{CR} ( {P}_{CR} , {RT}_{CR} , {B}_{CR} ) = \{ \begin{matrix}0 , {U}_{P}^{CR} ( {P}_{CR} ) = 0 or {U}_{RT}^{CR} ( {RT}_{CR} ) = 0 or {U}_{B}^{CR} ( {B}_{CR} ) = 0 \\ {ω}_{P}^{CR} {U}_{P}^{CR} ( {P}_{CR} ) + {ω}_{RT}^{CR} {U}_{RT}^{CR} ( {RT}_{CR} ) + {ω}_{B}^{CR} {U}_{B}^{CR} ( {B}_{CR} ) , others\end{matrix}$$
where ω_{P}^{CR}+ω_{B}^{CR}=1, and ω_{P}^{CR}, ω_{RT}^{CR}, and ω_{B}^{CR} are respective weights of a utility value U_{P}^{CR}(P_{CR}) of the adjustment factor P_{CR}, a utility value U_{RT}^{CR}(RT_{CR}) of the response time RT_{CR}, and a utility value U_{B}^{CR}(B_{CR}) of the bandwidth B_{CR} of the task request.

16. The apparatus of claim 15, wherein the second module includes:
an adjustment factor module for the task request configured to calculate a utility value of the adjustment factor P_{CR} of the task quest according to the following formula:
$${U}_{P}^{CR} ( {P}_{CR} ) = \{ \begin{matrix}{u}_{m i nP}^{CR} + ( 1 - {u}_{m i nP}^{CR} ) \cdot \vert \frac{{R}_{P}^{CR} - {P}_{CR}}{{R}_{P}^{CR} - {I}_{P}^{CR}} \vert , {I}_{P}^{CR} \leq {P}_{CR} \leq {R}_{P}^{CR} \\ 0 , others\end{matrix}$$
where u_{min P}^{CR} represents a minimum utility value of the adjustment factor of the task request, I_{P}^{CR} and R_{P}^{CR} represent a most expected adjustment factor and a least expected adjustment factor of the task request, respectively;
a response time module for the task request configured to calculate a utility value of the response time RT_{CR} of the task request according to the following formula:
$${U}_{RT}^{CR} ( {RT}_{CR} ) = \{ \begin{matrix}{u}_{m i nRt}^{CR} + ( 1 - {u}_{m i nRT}^{CR} ) \cdot \vert \frac{{R}_{RT}^{CR} - {R}_{CR}}{{R}_{RT}^{CR} - {I}_{RT}^{CR}} \vert , {I}_{RT}^{CR} \leq {RT}_{CR} \leq {R}_{RT}^{CR} \\ 0 , others\end{matrix}$$
where u_{min RT}^{CR} represents a minimum utility value of the response time of the task request, I_{RT}^{CR} and R_{RT}^{CR} represent a most expected response time and a least expected response time of the task request, respectively; and
a bandwidth module for the task request configured to calculate a utility value of the bandwidth B_{CR} of the task request according to the following formula:
$${U}_{B}^{CR} ( {B}_{CR} ) = \{ \begin{matrix}{u}_{m i nB}^{CR} + ( 1 - {u}_{m i nB}^{CR} ) \cdot \vert \frac{u ( {R}_{B}^{CR} ) - u ( {B}_{CR} )}{u ( {R}_{B}^{CR} ) - u ( {I}_{B}^{CR} )} \vert , {I}_{B}^{CR} \leq {B}_{CR} \leq {R}_{B}^{CR} \\ 0 , others\end{matrix}$$
where u_{min B}^{CR} represents a minimum utility value of the bandwidth of the task request, and I_{B}^{CR} and R_{B}^{CR} represent a most expected bandwidth and a least expected bandwidth of the task request, respectively.

17. The apparatus of claim 16, wherein u(B_{CR}), u(R_{B}^{CR}) and u(I_{B}^{CR}) are obtained by the following formula:
$$u ( X ) = \{ \begin{matrix}ωlog X , {I}_{B}^{CR} \leq X \leq {R}_{B}^{CR} \\ 0 , others\end{matrix}$$
where ω represents a parameter for controlling a function shape, and X is B_{CR}, R_{B}^{CR} or I_{B}^{CR}.

18. The apparatus of claim 14, further comprising:
a third module for obtaining the third integrated utility value U_{CP}^{total}(P_{CP},RT_{CP},B_{CP}) by the following formula:
$${U}_{total}^{CP} ( {P}_{CP} , {RT}_{CP} , {B}_{CP} ) = \{ \begin{matrix}0 , {U}_{P}^{CP} ( {P}_{CP} ) = 0 or {U}_{RT}^{CP} ( {RT}_{CP} ) = 0 or {U}_{B}^{CP} ( {B}_{CP} ) = 0 \\ {ω}_{P}^{CP} {U}_{P}^{CP} ( {P}_{CP} ) + {ω}_{RT}^{CP} {U}_{RT}^{CP} ( {RT}_{CP} ) + {ω}_{B}^{CP} {U}_{B}^{CP} ( {B}_{CP} ) , others\end{matrix}$$
where ω_{P}^{CP}+ω_{RT}^{CP}+ω_{B}^{CP}=1, ω_{P}^{CP}, ω_{RT}^{CP}, and ω_{B}^{CP} are respective weights of a utility value U_{P}^{CP}(P_{CP}) of the adjustment factor P_{CP}, a utility value U_{RT}^{CP}(RT_{CP}) of the response time RT_{CP}, and a utility value U_{B}^{CP} (B_{CP}) of the bandwidth B_{CP} of the resource.

19. The apparatus of claim 18, wherein the third module further includes:
an adjustment factor module for resource configured to calculate a utility value of the adjustment factor P_{CP} of the resource according to the following formula:
$${U}_{P}^{CP} ( {P}_{CP} ) = \{ \begin{matrix}{u}_{m i nCP}^{CP} + ( 1 - {u}_{m i nCP}^{CP} ) \cdot \vert \frac{{P}_{CP} - {R}_{P}^{CP}}{{I}_{P}^{CP} - {R}_{P}^{CP}} \vert , {R}_{P}^{CP} \leq {P}_{CP} \leq {I}_{P}^{CP} \\ 0 , others\end{matrix}$$
where u_{min P}^{CP} represents a minimum utility value of the adjustment factor P_{CP} of the resource, and I_{P}^{CP} and R_{P}^{CP} represent an initial adjustment factor and a reserved adjustment factor of the adjustment factor P_{CP} of the resource, respectively;
a response time module for the resource configured to calculate a utility value of the response time RT_{CP} of the resource according to the following formula:
$${U}_{RT}^{CP} ( {RT}_{CP} ) = \{ \begin{matrix}{u}_{m i nCP}^{CP} + ( 1 - {u}_{m i nCP}^{CP} ) \cdot \vert \frac{{RT}_{CP} - {R}_{RT}^{CP}}{{I}_{RT}^{CP} - {R}_{RT}^{CP}} \vert , {R}_{RT}^{CP} \leq {RT}_{CP} \leq {I}_{RT}^{CP} \\ 0 , others\end{matrix}$$
where u_{min RT}^{CP} represents a minimum utility value of the response time of the resource, I_{RT}^{CP} and R_{RT}^{CP} represent an initial response time and a reserved response time of the resource, respectively; and
a bandwidth module for the resource configured to calculate a utility value of the bandwidth B_{CP} of the resource according to the following formula:
$${U}_{B}^{CP} ( {B}_{CP} ) = \{ \begin{matrix}{u}_{m i nB}^{CP} + ( 1 - {u}_{m i nB}^{CP} ) \cdot \vert \frac{{B}_{CP} - {R}_{B}^{CP}}{{I}_{B}^{CP} - {R}_{B}^{CP}} \vert , {R}_{B}^{CP} \leq {B}_{CP} \leq {I}_{B}^{CP} \\ 0 , others\end{matrix}$$
where u_{min B}^{CP} represents a minimum utility value of the bandwidth of the resource, and I_{B}^{CP} and R_{B}^{CP} represent an initial bandwidth and a reserved bandwidth of the resource, respectively.

20. The apparatus of claim 14, further comprising a task scheduling module for receiving the cloud-based media task request.

21. The apparatus of claim 20, wherein the resource allocation module allocates the resource to the task request when the service negotiation module determines that the first integrated utility value is not less than the second integrated utility.

22. The apparatus of claim 20, wherein the cloud-based media task request corresponds to a plurality of first integrated utility values when there are a plurality of cloud-based media resources, and each of the plurality of first integrated utility values corresponds to a cloud-based media resource; and
wherein if the service negotiation module determines a maximum first integrated utility value is not less than the second integrated utility value, the resource allocation module allocates the cloud-based media resource corresponding to the maximum first integrated utility value to the task request.

23. The apparatus of claim 14, further comprising:
a timeout detecting module configured to detect a timeout of the task request when the integrated utility value of the task request is zero,
wherein if the timeout is detected, the allocation of the cloud-based media resources ends, and wherein if the timeout is not detected, a concession policy is executed.

24. The apparatus of claim 23, further comprising a concession policy module configured to repeatedly determine the second integrated utility value of the task request until the second integrated utility value of the task request is not zero.

25. The apparatus of claim 24, wherein the concession policy module executes the concession policy by performing the following:
obtaining a second integrated utility of a next task request based on a second integrated utility of a current task request by the following formula:
Uₜₒₜₐₗ^{CR}(P_{CR},RT_{CR},B_{CR})ₜ₊₁=Uₜₒₜₐₗ^{CR}(P_{CR},RT_{CR},B_{CR})ₜ−ΔUₜₒₜₐₗ^{CR}
wherein Uₜₒₜₐₗ^{CR}(P_{CR},RT_{CR},B_{CR})ₜ₊₁ is the second integrated utility value of the current task request, and ΔUₜₒₜₐₗ^{CR} is a step size of concessions.

26. The apparatus of claim 25, wherein the step size of concessions is determined according to the following formula:
$$Δ {U}_{total} = {U}_{total}^{t} \cdot {( \frac{t}{τ} )}^{λ}$$
where τ is a cut-off time, and t is a number of negotiations, and λ is a parameter of controlling a concession rate, 0≦λ≦10.
